(19) United States
(12) Patent Application Publication
(10) Pub. No.: US 2016/0189313 A1
(43) Pub. Date: Jun. 30, 2016

(54) CONTENT PUBLISHING SYSTEM SERVER AND PROGRAM

(71) Applicant: DeNA Co., Ltd., Tokyo (JP)

(72) Inventors: Yoichiro WATANABE, TOKYO (JP); Ryota YASUE, Tokyo (JP)

(21) Appl. No.: 14/975,283

(22) Filed: Dec. 18, 2015

(30) Foreign Application Priority Data
Dec. 26, 2014 (JP) 2014-264662

(51) Int. Cl. G06Q 40/00; H04L 29/08

(52) U.S. Cl. CPC G06Q 40/12; H04L 67/1097

(57) ABSTRACT

A period setting module 30 constituting a content publishing server 12 sets a plurality of periods that do not overlap each other in the period starting at the publication of content uploaded from creator terminals 14 for each content. An earnings setting module 32 sets the amount of earnings for each period that is set. The amount of earnings is set higher the closer a period is to the time of publication. The content publishing server 12 receives content access requests from a user terminal 16, and allocates to the content provider an amount of earnings that has been set for the period during which said content was transmitted to the user terminal 16.

The present application claims the benefit of Japanese Patent Application No. JP2014-264662, filed on Dec. 26, 2014, the content of which is incorporated herein in its entirety by reference.

### BACKGROUND

1. Technical Field

The present invention relates to a content publishing system server and program (e.g., non-transitory computer readable medium having machine-executable instructions with which a computer having a storage and a hardware processor).

2. Related Art

With related art content publishing systems, digital comics, movies, music, and other such content (electronic content) can be published by uploading to a server. Among these content publishing systems, there are systems that distribute earnings obtained through content usage fees, advertising fees, etc., to the content right holder (such as the creator of the content).

For instance, Patent Document 1 discloses a system in which the content used by a user (the content user) is stored in a storage area allocated to that user, and content that has already been used is deleted from this storage area, wherein the system distributes earnings to the provider of the content on the basis of how long the content was stored in the storage area.

### PRIOR ART DOCUMENT

### Patent Document

[Patent Document 1] Japanese Patent Application 2014-123318

### SUMMARY OF THE INVENTION

### Problems to be Solved by the Invention

As an example of Patent Document 1, various content publishing systems for distributing earnings to content providers have been proposed, but no content publishing system has been proposed in which earnings are distributed to content providers according to how much time passes between publication of the content and the provision of the content to the user.

### SUMMARY

It is an object of the present invention to provide a content publishing system with which earnings corresponding to how much time passes between content publication and the provision of the content to the user can be distributed to a content provider.

The present invention is a server for a content publishing system that publishes on an information network a plurality of content objects provided by a plurality of content providers, said content publishing server comprising: a period setting means, capable of accessing a content storage means for storing content, for setting a plurality of periods that do not overlap each other in the period starting at the publication of said content for each content object stored in the content storage means; a content access enabling means for allowing, in response to a request from a user terminal used by a user who is a content user, content designated in the request, out of the content stored in the content storage means, to be accessed at the user terminal; and an earnings provision means for giving the provider of said content earnings that vary depending on the period during which content access was enabled by the content access enabling means, out of the plurality of periods.

Preferably, the server for a content publishing system further comprises an information acquisition means for acquiring content and setting instructions for the plurality of periods set for said content from the content provider, wherein the content acquired by the information acquisition means is stored in the content storage means, and the period setting means sets a plurality of periods that do not overlap each other in the period starting at the publication of said content, according to the setting instructions for the content acquired by the information acquisition means.

Preferably, out of the plurality of periods, the earnings provision means gives the content provider earnings that are higher the earlier the period is during which the content access was enabled by the content access enabling means.

Preferably, the server for a content publishing system further comprises a fee collection means for collecting a higher fee from the user the earlier the period is during which the content access was enabled by the content enabling means, out of the plurality of periods, wherein the earnings provision means gives the content provider all or part of the fee as said earnings.

Preferably, the server for a content publishing system further comprises a determination means for determining whether or not content that is the same as the content stored in the content storage means has been published on an information network by other systems besides the content publishing system, wherein the earnings provision means gives lower earnings when content that is the same as the content provided by the content access enabling means has been published by the other systems in at least one period out of the plurality of periods.

Also, the present invention is a program (e.g., non-transitory computer readable medium having machine-executable instructions with which a computer having a storage and a hardware processor) for causing a computer to function as a server for a content publishing system that publishes on an information network a plurality of content objects provided by a plurality of content providers, said computer being capable of accessing a content storage means for storing content, said program causing the computer to function as: a period setting means for setting a plurality of periods that do not overlap each other in the period starting at the publication of said content, for each content object stored in the content storage means; a content access enabling means for allowing, in response to a request from a user terminal used by a user who is a content user, content designated in the request, out of the content stored in the content storage means, to be accessed at the user terminal; and an earnings provision means for giving the provider of said content earnings that vary depending on the period during which content access was enabled by the content access enabling means, out of the plurality of periods. Further, a non-transitory computer readable medium having machine-executable instructions with which a computer having a storage and a hardware processor is provided, for causing a computer to function as a server for a content publishing system that publishes on an information network a plurality of content objects provided by a plurality of content providers, said computer being capable of accessing a content storage for storing content, said instructions comprising setting a plurality of periods that do not overlap each other in the period starting at the publication of said content, for each content object stored in the content storage; allowing, in response to a request from a user terminal used by a user who is a content user, content designated in the request, out of the content stored in the content storage, to be accessed at the user terminal; and giving the provider of said content earnings that vary depending on the period during which content access was enabled by the allowing, out of the plurality of periods.

### Effect of the Invention

The present invention provides a content publishing system with which earnings corresponding to how much time passes from content publication until the provision of the content to the user can be distributed to a content provider.

### BRIEF DESCRIPTION OF THE DRAWINGS

FIG. 1 is a simplified diagram of the overall configuration of the content publishing system pertaining to the present invention.

FIG. 2 is a simplified diagram of the configuration of a content publishing server.

FIG. 3 is a diagram of an example of a digital comic upload screen.

FIG. 4 is a diagram of an example of a pre-reading period set for a digital comic.

FIG. 5 is a diagram of an example of the data structure of a content database.

FIGS. 6(a) and 6(b) are display examples of a published digital comic list.

FIG. 7 is an example of a screen for selecting pre-reading conditions.

FIG. 8 is an example of a sales summary screen.

FIG. 9 is a flowchart of an example of the flow of processing in the content publishing system in an embodiment.

### DETAILED DESCRIPTION

Embodiments of the present invention will now be described through reference to the drawings. The term “content” as used in this Specification refers to digital comics, movies, music, and other such content, as well as the data of these.

### Content Publishing System

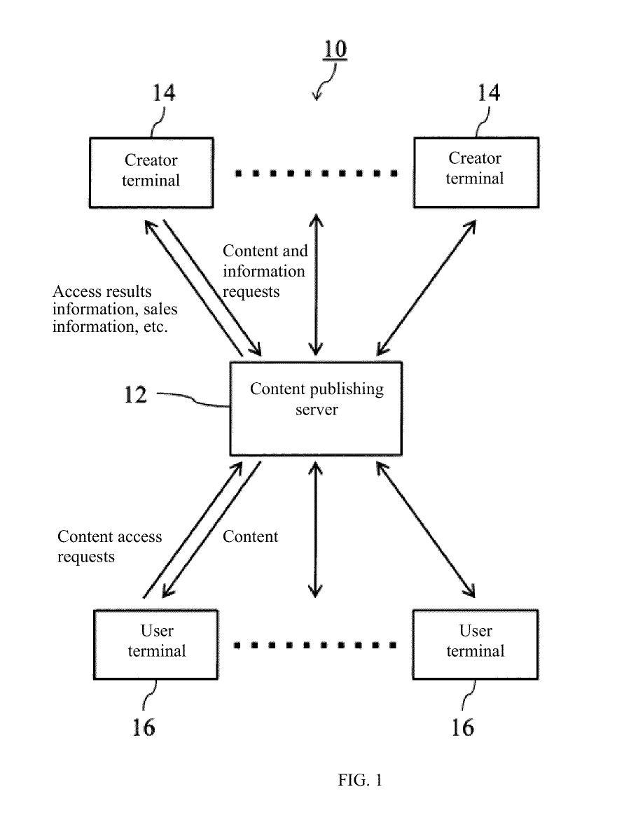

FIG. 1 is a simplified diagram of the configuration of a content publishing system 10. The content publishing system 10 is constituted by a content publishing server 12, a plurality of creator terminals 14, and a plurality of user terminals 16. The content publishing server 12 and the creator terminals 14, as well as the content publishing server 12 and the user terminals 16 are connected so as to be able to communicate with each other through the Internet or another such network.

The content publishing server 12 is a server computer, and a computer having specifications that allow its application as a web server is used. The creator terminals 14 and the user terminals 16 may be any computer that is commonly used, namely, a PC (personal computer) or a smart phone or other such portable terminal, etc.

The creator terminals 14 are used by the content provider (typically, the creator of this content and hereinafter referred to as the “creator”). The user terminals 16 are used by the user who is the user of the content published by the content publishing server 12.

The content publishing system 10 stores content uploaded from creator terminals 14, and publishes this content on the Internet. The term “publish” as used here means assigning a specific URL to the content, and putting it in a state in which it can be accessed at any time from another terminal (that is, it can be transmitted to another terminal). Examples of the content published by the content publishing system 10 include digital comics, images, movies, music, and application software.

The content publishing system 10 sends content to the user terminals 16 in response to access requests from the user terminals 16. This makes it possible for content uploaded from the creator terminals 14 to be used at the user terminals 16. Alternatively, if content with an access restriction has been sent from the content publishing system 10 ahead of time to the user terminals 16, and the user has met a specific condition (discussed below), the content publishing system 10 may eliminate this access restriction so that the content can be accessed at the user terminals 16. The content publishing system 10 also sends the creator terminals 14 access result information indicating access results for uploaded content, sales information indicating sales resulting from the access of content, and so forth in response to requests from the creator terminals 14.

### Content Publishing Server

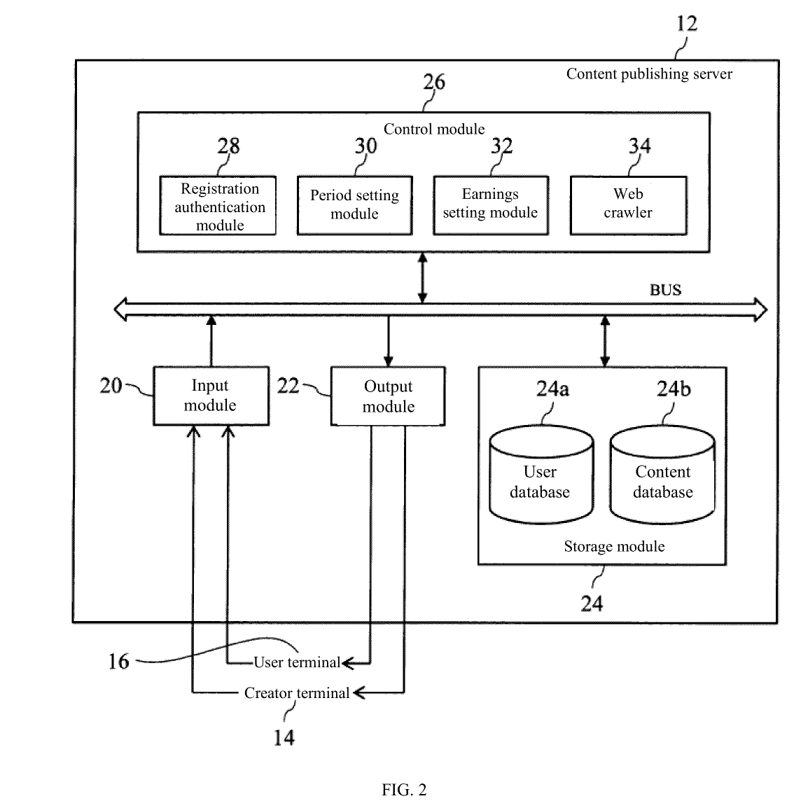

The specific processing performed by the content publishing server 12 will now be described through reference to FIG. 2.

FIG. 2 is a simplified diagram of the configuration of the content publishing server 12. The content publishing server 12 has an input module 20, an output module 22, a storage module 24, and a control module 26, and these are electrically connected by a bus. The control module 26 also functions as a registration authentication module 28, a period setting module 30, an earnings setting module 32, and a web crawler 34.

The input module 20 receives requests for various kinds of information or content transmitted from the creator terminals 14, content access requests transmitted from the user terminals 16, and so forth. The output module 22 sends content to the user terminals 16 according to instructions from the control module 26, and sends various kinds of information to the creator terminals 14. That is, the input module 20 and the output module 22 are communication modules for communicating with the creator terminals 14 and the user terminals 16 via the Internet.

The storage module 24 is a hard disk or a memory, for example, and stores programs (e.g., non-transitory computer readable medium having machine-executable instructions with which a computer having a storage and a hardware processor) used for the functioning of the various modules of the content publishing server 12. The storage module 24 has a user database 24a and a content database 24b. Information about creators and users who are registered as users of the content publishing system 10 is stored as a database in the user database 24a. Content uploaded from the creator terminals 14 and attribute information about said content are stored as a database in the content database 24b.

The storage module 24 also stores registration information input forms for inputting specific information during creator or user registration processing, upload forms used by creators in the uploading of content, and the like. In this embodiment, the storage module 24 is included in the content publishing server 12, but a storage module that includes a user database and a content database may be installed outside of the content publishing server 12. In this case, however, this storage module is still connected so that it can communicate with the content publishing server 12 via the Internet or another such network.

A specific URL is assigned to the content stored in the content database 24b, so that it can be accessed from the user terminals 16. In other words, the content is published. Rather than being published immediately after being stored in the content database 24b, the content may be published on the basis of an instruction from the creator who uploaded that content.

The control module 26 is a CPU, for example, and controls the entire content publishing server 12 according to commands of the programs (e.g., non-transitory computer readable medium having machine-executable instructions with which a computer having a storage and a hardware processor) stored in the storage module 24. The various functions of the control module 26 will now be described.

The registration authentication module 28 performs registration and authentication of creators and users to the content publishing system 10. For instance, upon receiving a user registration request from a user terminal 16, the registration authentication module 28 reads the registration information input form from the storage module 24 and sends it to the user terminal 16. When specific information required for said form at the user terminal 16 (address, name, credit card information used for payment, etc.) is inputted and sent back, the registration authentication module 28 performs user registration processing on the basis of this information. More specifically, a user ID that identifies a registered user is associated with inputted information and stored in the user database 24a. The registration authentication module 28 also performs user authentication processing (login processing) on the basis of the user ID sent from a registered user, a password, etc. Registration and authentication processing is similarly performed for creators.

For each content object uploaded to the content database 24b, the period setting module 30 sets a plurality of periods that do not overlap each other in the period starting at the publication of content. That is, the period starting at the publication of content is divided up into a plurality of periods. For example, if the start of content publication is at 5:00 pm on December 8, the settings could be such that a first period is from 5:00 pm on December 8 until 5:00 pm on December 15, a second period is from 5:00 pm on December 15 until 5:00 pm on December 22, and a third period is from 5:00 pm on December 22 onward. Naturally, the number of periods that are set may be two, or may be four or more.

The period setting module 30 sets a plurality of periods according to instruction information sent from the creator terminals 14 (that is, according to instructions from the creators). In other words, the creators designate the number of periods, and the start and end times of the various periods. Alternatively, the period setting module 30 may determine the number of periods, the length of the various periods, and so forth according to the attributes of the uploaded content. For instance, the length of each period may be increased in proportion to the volume of the content (such as the number of pages in the case of a digital comic).

The period setting module 30 sets a specific condition (content access condition) required for a user to access the content for each period. The content access condition may be, for example, the payment of a certain amount of money, the downloading of a specific application, the spending of a certain number of points, or the viewing of a certain advertisement for a certain length of time.

Here, the content access condition that is set for each period is set so as to be a stricter condition the earlier the period is, that is, the closer the period is to the start of content publication. A “stricter condition” means that if the content access condition is an amount of money, the access fee is higher. For example, if three periods have been set as in the above example, the first period (that is, the period closest to the start of publication) is set to 200 yen, the second period (that is, the period that is next closest to the start of publication) is set to 100 yen, and the third period (that is, the period farthest away from the start of publication) is set to 0 yen. Naturally, the amounts of money may be changed as desired. Similarly, other conditions may be set in each period, such as changing the number of applications to be downloaded, changing the number of points to be spent, changing the length of time the advertisement is to be viewed, etc.

The earnings setting module 32 sets the amount of earnings for each period set by the period setting module 30. “Earnings” is typically an amount of money, but is not limited to this, and may instead be the number of points that can be used at a particular site, etc. After the publication of content, that content is transmitted to a user terminal 16 in response to an access request from the user terminal 16, and the amount of earnings set for the period during which the content is transmitted to the user terminal 16 is allocated to the creator of that content.

For the periods set by the period setting module 30, the earnings setting module 32 sets the amount of earnings higher for periods closer to the start of content publication. For instance, when three periods are set as in the above example, 10 yen is set for the first period, 5 yen for the second period, and 0 yen for the third period. Consequently, the earlier an access request is received after the publication of the content, the more earnings are allocated to the creator of that content. Of course, the amount of the earnings may be set differently from those above.

These earnings are allocated from the revenue of the content publishing system 10. For example, all or part of the money collected from users as a content access condition may be allocated as creator earnings. For instance, if 100 yen is collected from a user as a content access condition, 10% of that, or 10 yen, may be allocated to the creator. Or, if 200 yen is collected from a user, 10% of that, or 20 yen, may be allocated to the creator. Thus, an amount corresponding to the amount collected from the users may be allocated as the earnings of a creator.

The earnings setting module 32 may also vary the amount of earnings set for the various periods according to the search results of the web crawler 34. The web crawler 34 performs a comprehensive search for information related to content (or for the content itself) published on the Internet by other systems besides the content publishing system 10. More specifically, an Internet search is performed to determine whether or not content that is the same as the content uploaded to the content database 24b has been published by other systems.

For the content uploaded to the content database 24b, the earnings setting module 32 sets the amount of earnings for the content discovered by the web crawler 34 to have been published on other systems (content that has also been published by other systems) lower than for content that has not (content that has been published only by the content publishing system 10). To put this the other way, the amount of earnings for content that has been published only by the content publishing system 10 is set higher than the amount of earnings for content that has also been published on other systems.

For instance, when three periods have been set as in the above example, for content that has been published only by the content publishing system 10, the first period is set to 20 yen, the second period to 10 yen, and the third period to 0 yen. For content that has been published by other systems, the first period is set to 10 yen, the second period to 5 yen, and the third period to 0 yen. Thus, for at least one of the plurality of periods, the amount of earnings for content published only by the content publishing system 10 is set higher than the amount of earnings for content that has been published on other systems.

Therefore, from a creator's perspective, more can be earned by uploading content just to the content publishing system 10, so this is a way to make creators upload content only to the content publishing system 10. That is, creators can be prevented from uploading the same content to other systems by varying the amount of earnings set for each period according to the search results of the web crawler 34.

### Uploading Content

The processing involved in uploading content from a creator terminals 14 to the content publishing server 12 will now be described through reference to FIGS. 2 and 3 to 5. The following description will be of an example in which the published content is a story from a digital comic.

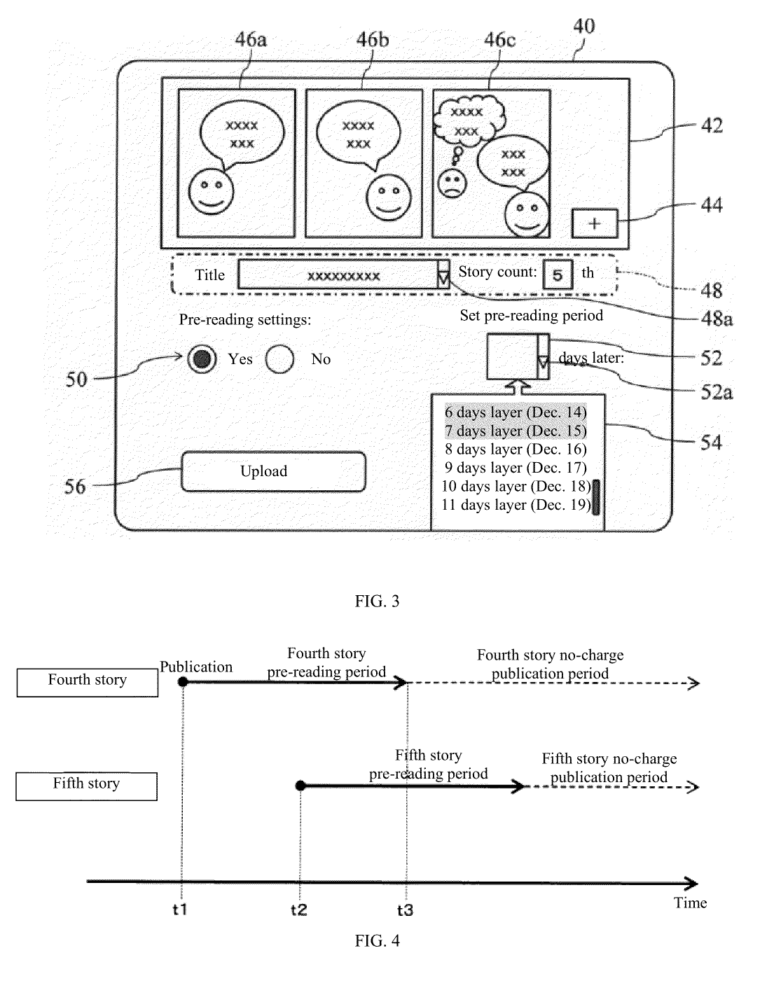

In uploading story data, the creator sends a request for an upload form from the creator terminal 14 to the content publishing server 12. Upon receiving this request, the content publishing server 12 reads the upload form from the storage module 24 and sends it to the creator terminal 14. FIG. 3 shows an example of an upload form that is displayed on the display module 40 of the creator terminal 14.

The upload form has an upload option image display module 42. The creator clicks on an add image button 44 to select images stored in the creator terminal 14 or on a storage medium that can be accessed from the creator terminal 14. These images constitute each page of the story. The selected images are displayed on the upload option image display module 42 as upload option images. In the example in FIG. 3, three upload option images 46a, 46b, and 46c are shown. Naturally, many images can be uploaded at once, in which case the display of images is switched by laterally scrolling, for example, within the upload image option display module 42.

An image group that is uploaded in a single upload operation constitutes a single story, so a plurality of images constituting a single story in a comic are generally selected as the upload option images. It is also possible, of course, to add images (i.e., pages) to the story that has already been uploaded.

The upload form has a title/story count input area 48. The creator inputs the title of the stories and the story count to be uploaded in the title/story count input area 48. Clicking on an arrow 48a provided within the title input box displays a list of titles that have been given to the stories already uploaded by the creator.

The upload form also has a pre-reading setting radio button 50 for toggling between setting and not setting pre-reading, and a pre-reading expiration setting box 52. Selecting whether or not to set pre-reading entails selecting whether or not to use the above-mentioned period setting module 30 to set a plurality of periods for the period starting at the publication of the story. In this example, when “yes” is selected for the pre-reading setting, the period setting module 30 divides the period after the publication of this story into two periods, namely, a pre-reading period and a subsequent period (no-charge publication period). When “no” is selected for the pre-reading setting, the period setting module 30 does not perform processing to divide the period after the publication of this story.

In this example, the earnings setting module 32 sets 10 yen as the amount of earnings for the pre-reading period and sets 0 yen as the amount for the no-charge publication period. Therefore, if there is a request from a user to view the story during the pre-reading period and the story is sent to the user terminal 16, 10 yen will be allocated to the creator of that story. If the story is sent to the user terminal 16 during the no-charge publication period, no earnings will be allocated to the creator.

When “yes” is selected with the pre-reading setting radio button 50, the creator inputs the pre-reading expiration in the pre-reading expiration setting box 52. The “pre-reading expiration” indicates how long the pre-reading period will last after publication, that is, the end point of the pre-reading period and the starting point of the no-charge publication period. When the arrow button 52a provided within the pre-reading expiration setting box 52 is clicked, a selectable pre-reading expiration list 54 is displayed. In this example, the pre-reading expiration can be set to a maximum length of 14 days later, in one-day units from the start of publication. Of course, the pre-reading expiration may instead be set in one-hour units, or may be set to a longer time period. The creator selects the desired expiration from among the pre-reading expirations displayed in the pre-reading expiration list 54.

In this example, out of the pre-reading expirations given in the pre-reading expiration list 54, “after seven days (December 16) and earlier” cannot be selected. This will be described through reference to FIG. 4 below.

There are cases in which a content group is formed that includes a plurality of content objects having context. To use a digital comic as an example, an digital comic generally consists of a series of a plurality of stories told in serial fashion, and a plurality of continuous stories (content) consisting of a first story, a second story, a third story, and so forth form a single title (content group). In this case, if the pre-reading expiration of the fifth story of a given title ends up being set earlier than the pre-reading expirations of the stories that come before the fifth story (the first to fourth stories), then a situation would occur in which, during a given period, the fourth story is within the pre-reading expiration period, and the fifth story is within the no-charge publication period. That is, a situation occurs in which the user can view the fifth story at no charge, despite having to pay a certain amount to view the fourth story. Since this is unacceptable, the pre-reading expiration of the fifth story can be set only to later than the pre-reading expirations of the first to fourth stories, which come before it.

FIG. 4 is a graph of this relationship. The fourth story is published at a time t1, and a time t3 is set as the pre-reading expiration of the fourth story. That is, the pre-reading expiration of the fourth story is set to the period between the times t1 and t3. If the fifth story of the same title is published at a time t2, which is before the time t3 but after the publication of the fourth story, then a time earlier than the time t3 that is the pre-reading expiration of the fourth story cannot be set as the pre-reading expiration of the fifth story. In other words, the pre-reading expiration of the fifth story cannot be between the times t2 and t3. Therefore, the creator sets the pre-reading expiration for the fifth story to be at or after the time t3.

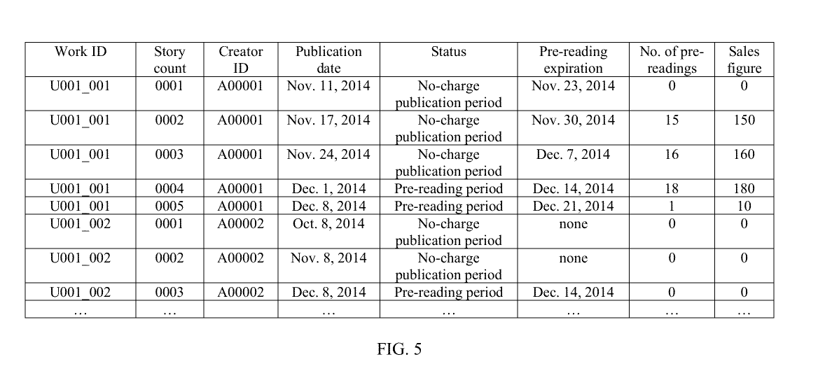

More specifically, when the creator uploads a story, the publication date and the pre-reading of that story are stored in the content database 24b and associated with this content (see FIG. 5 (discussed below) for the structure of the content database 24b). For instance, the time t1, which is the publication date of the fourth story, and the time t3, which is the pre-reading expiration of the fourth story, are stored in the content database 24b. In uploading the fifth story, the period setting module 30 reads the pre-reading expirations of the first to fourth stories, which come before the fifth story, from the content database 24b and prohibits the pre-reading expiration of the fifth story from being set earlier than the pre-reading expirations of these preceding stories.

Returning to FIG. 3, when an upload button 56 is clicked after the creator has inputted various information to the upload form, a single story including a plurality of image data objects is uploaded to the content publishing server 12. The period setting module 30 divides up the period after the publication of said story into a pre-reading period and a no-charge publication period on the basis of the pre-reading expirations inputted using the pre-reading expiration setting box 52 and the pre-reading setting radio button 50.

Thus, in this example, the creator can specify whether or not to divide up the period after the publication of content (a story), and, if it is to be divided, pre-reading expirations. If there is a viewing request from a user terminal 16 during the pre-reading period, that creator can obtain a dividend. Naturally, if a pre-reading period is set longer, the period during which dividends can be obtained will also be longer, but the downside is that this may diminish a user's motivation to purchase. The creator sets the pre-reading expiration by taking these factors into account. That is, the earnings distribution method of the content publishing system 10 reflects the intent of the creator, a strategy to increase purchasing, etc.

FIG. 5 shows the data structure in the content database 24b. The content database 24b has a table structure, and the work ID assigned to each title of a digital comic, the number of stories for the title, the creator ID that identifies the creator of said title, the publication date, the current status (indicating whether it is in the pre-reading period or the no-charge publication period), the set pre-reading expiration, the number of pre-readings, and the sales figure are all associated with each other. The term “sales figure” here means the total value of dividends obtained by receiving view requests during the pre-reading period.

### Viewing from a User Terminal

The processing involved in viewing a digital comic from a user terminal 16 will now be described through reference to FIGS. 1 and 2, and FIGS. 6 and 7.

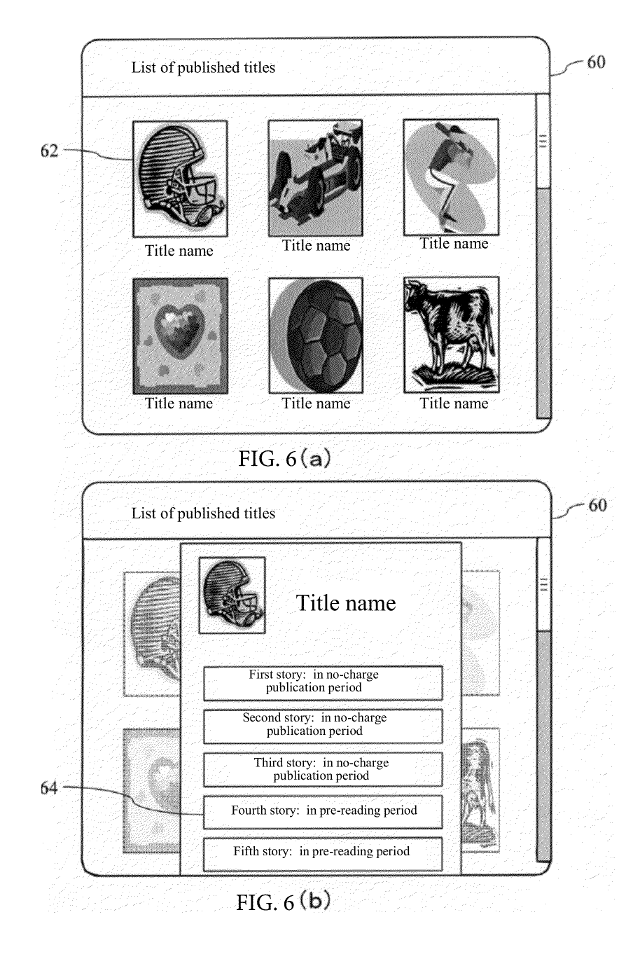

When a published title listing page published by the content publishing server 12 is accessed from a user terminal 16, the published title listing page shown in FIG. 6a is displayed on the display module 60 of the user terminal 16. On the published title listing page are displayed images corresponding to a plurality of titles uploaded by a plurality of creators, along with their title names.

When the user clicks on one of the title images in FIG. 6a, detailed information about that title is displayed. For instance, if the user clicks on the title image 62 in FIG. 6a, a list of the stories that have been uploaded for that title is displayed along with the status of each story as shown in FIG. 6b. The “status” here is information indicating whether a story is in its pre-reading period or is in the no-charge publication period.

In the example in FIG. 6b, the first to third stories are shown to be in the no-charge publication period. The fourth and fifth stories, on the other hand, are shown to be in their pre-reading period. If a user selects a story that is in its pre-reading period, a screen will be displayed to select the condition for viewing that story.

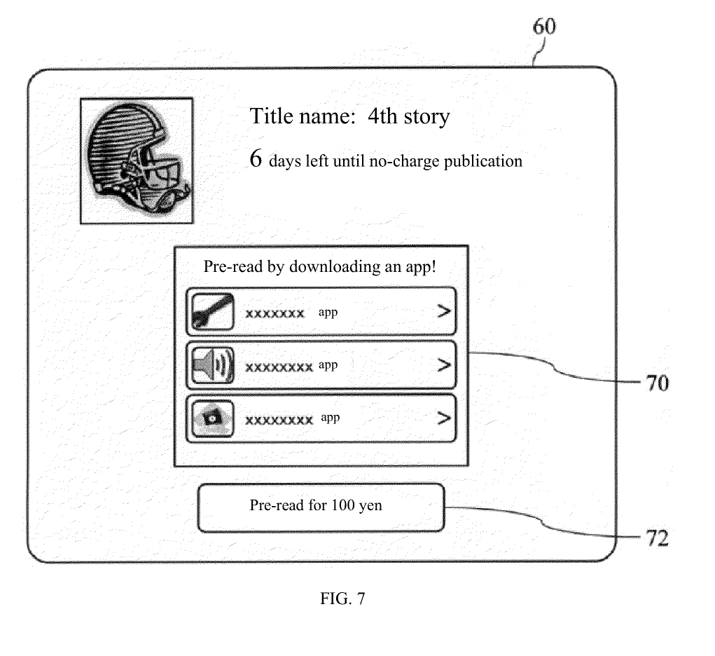

For instance, in the example in FIG. 6b, if the fourth story, which is in its pre-reading period, is selected, the pre-reading condition selection screen shown in FIG. 7 is displayed. In this example, there are two possible selections: to download one specific application as the pre-reading condition for viewing the fourth story that is in its pre-reading period, or to pay a specific amount of money (100 yen). That is, in this example, the period setting module 30 sets the condition for viewing the story in the pre-reading period as “download one specific application or pay 100 yen.”

If the first to third stories that are in the no-charge publication period are selected, the content will be sent to the user terminal 16 without first displaying the condition selection screen. That is, the period setting module 30 sets “without condition” as the viewing condition of a story in its no-charge publication period.

When the user opts to download a specific application as the viewing condition, this download is performed by clicking on the desired application from a download option application list 70 displayed on the viewing condition selection screen. When the user opts to pay 100 yen as the viewing condition, the user clicks a button 72 to pay the 100 yen. The collection of the 100 yen may be performed by the control module 26 on the basis of credit card information registered in the user database 24a, or by accepting some other form of payment.

Once the user has satisfied the viewing condition, the fourth story, which is in its pre-reading period, is sent to the user terminal 16.

When a story is sent to the user terminal 16 during the pre-reading period, 10 yen is allocated to the creator of that story. The allocated amount is added to the sales figure associated with that story in the content database 24b shown in FIG. 5. The sales figure is paid out to the creator at certain intervals, such as once a month.

In this example, when the user has satisfied the viewing condition, a story, which is in its pre-reading period, is sent to the user terminal 16, but as discussed above, if the user satisfies the viewing condition after a story in its pre-reading period has already been sent to the user terminal 16 (in this state, a viewing restriction applies, and the user cannot view the story), the user may be allowed to view that story, such as by having the content publishing server 12 send the user terminal 16 a password for removing the viewing restriction.

### Viewing the Sales Status

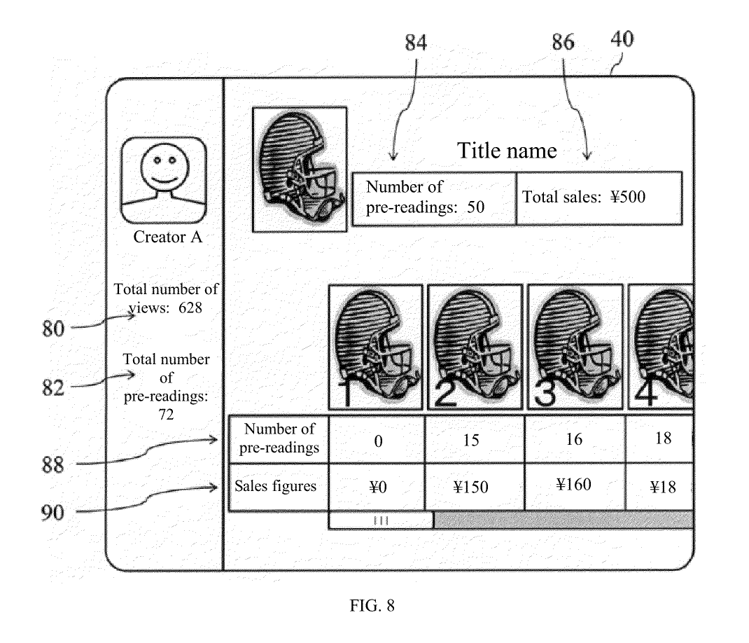

FIG. 8 shows a sales information display screen that is displayed on the display module 40 of a creator terminal 14. When a sales information request is transmitted from the creator terminal 14, the control module 26 sends sales information to the creator terminal 14, and the screen shown in FIG. 8 is displayed on the display module 40 of the creator terminal 14.

On this sales information display screen are displayed the total view count 80 and total pre-readings 82 for all of the stories uploaded by a creator, the number of pre-readings 84 and the total sales 86 by title, and the number of pre-readings 88 and the total sales 90 by story. More specifically, the control module 26 refers to the content database 24b, reads the number of pre-readings and the total sales for each story, calculates the sales figure and the number of pre-readings for every title on the basis of the work ID, also calculates the sales figure and the number of pre-readings for every creator on the basis of the creator ID, and sends the information to the creator terminal 14, where the information is displayed on the creator terminal 14.

This allows a creator to see at-a-glance information about which stories of which titles have been pre-read the most, etc. In the example in FIG. 8, the number of pre-readings and sales figures are displayed by story in a table format, but may instead be displayed as a graph or in another format.

A creator can research a story's contents and composition on the basis of the number of pre-readings or sales figures. More specifically, the contents and composition that attract the most attention among users can be studied by analyzing the contents and composition of the story with the most pre-readings (or the one just before it).

### Flow of Processing

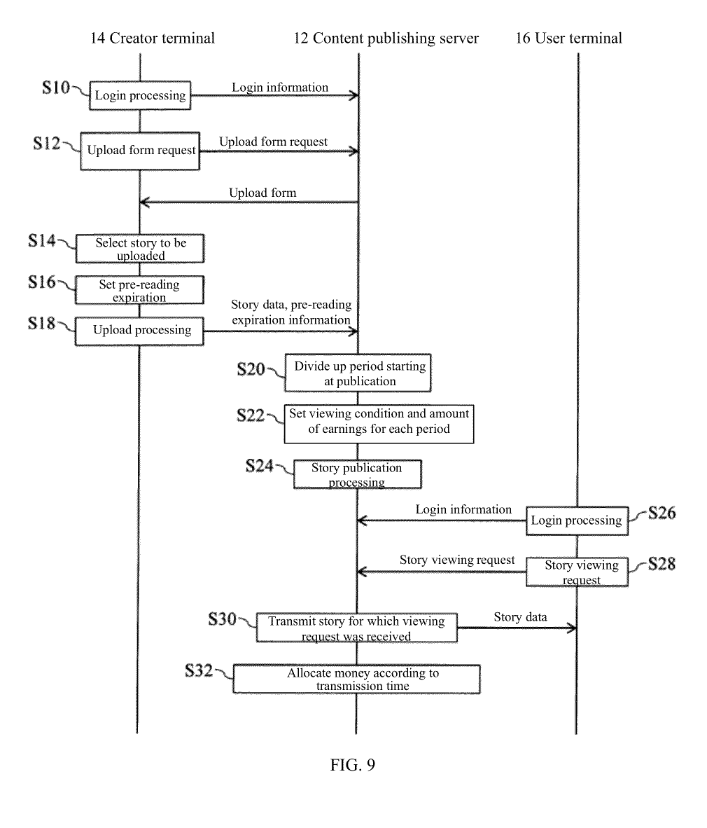

The flow of processing in the content publishing system 10 will now be described through reference to FIGS. 1 and 2 and to the flowchart in FIG. 9.

In step S10, the creator logs in by inputting login information (creator ID, password, etc.) to the creator terminal 14. The inputted login information is sent to the content publishing server 12, and is authenticated by the registration authentication module 28.

In step S12, the creator sends a request from the creator terminal 14 to the content publishing server 12 for an upload form in order to upload a story (content). Upon receiving the request for an upload form, the content publishing server 12 sends the upload form to the creator terminal 14.

In step S14, the creator selects a plurality of image data objects on the upload form to be uploaded to the content publishing server 12. These image data make up a single story. In step S16, the creator uses the upload form to set whether or not pre-reading will be set for this story (we will assume that pre-reading is set in this example), and to set the pre-reading expiration. Once all of the required settings have been completed, upload processing is performed in step S18. This upload processing results in the image data that constitutes the story data and information about the pre-reading expiration for this story being sent to the content publishing server 12.

In step S20, the period setting module 30 divides the period starting at the publication of the uploaded story into a pre-reading period and a no-charge publication period on the basis of the pre-reading expiration set by the creator.

In step S24, the period setting module 30 sets the viewing condition for the pre-reading period and the no-charge publication period set for the uploaded story. In this example, the condition set for the pre-reading period is “to download a single specific application or pay 100 yen,” and “without condition” for the no-charge publication period. Also, the earnings setting module 32 sets the amounts to be allocated to the creator for the pre-reading period and the no-charge publication period set for the uploaded story. In this example, “10 yen” is set for the pre-reading period, and “0 yen” is set for the no-charge publication period.

In step S24, the content publishing server 12 stores the received plurality of image data objects as a single story data object in the content database 24b, and assigns a specific URL to this story. The content upload processing is concluded with the processing up to step S24.

In step S26, the user logs in by inputting login information (user ID, password, etc.) to the user terminal 16. The inputted login information is sent to the content publishing server 12, and is authenticated by the registration authentication module 28.

In step S28, the user selects the desired story from among the stories published by the content publishing server 12, and transmits a request to view this story from the user terminal 16. If the story selected by the user is in its pre-reading period, a view request for that story is transmitted once a specific condition (the download of an application or the payment of a fee) has been satisfied.

In step S30, the content publishing server 12 transmits to the user terminal 16 the story data for which a view request was received from that user terminal 16. In step S32, if the point in time when the story data is transmitted is within the pre-reading period, the content publishing server 12 allocates the amount (10 yen) set for the pre-reading period to the creator who uploaded that story data. Also, if the point when the story data is transmitted is within the no-charge publication period, no earnings are allocated to the creator who uploaded that story data.

### DESCRIPTION OF THE REFERENCE NUMERALS

10 Content publishing system
12 Content publishing server
14 Creator terminal
16 User terminal
20 Input module
22 Output module
24 Storage module
24a User database
24b Content database
26 Control module
28 Registration authentication module
30 Period setting module
32 Earnings setting module
34 Web crawler

1. A server for a content publishing system that publishes on an information network a plurality of content objects provided by a plurality of content providers, said content publishing server comprising:
a period setting means, capable of accessing a content storage means for storing content, for setting a plurality of periods that do not overlap each other in the period starting at the publication of said content for each content object stored in the content storage means;
a content access enabling means for allowing, in response to a request from a user terminal used by a user who is a content user, content designated in the request, out of the content stored in the content storage means, to be accessed at the user terminal; and
an earnings provision means for giving the provider of said content earnings that vary depending on the period during which content access was enabled by the content access enabling means, out of the plurality of periods.

2. The server for a content publishing system according to claim 1, further comprising:
an information acquisition means for acquiring content and setting instructions for the plurality of periods set for said content from the content provider,
wherein the content acquired by the information acquisition means is stored in the content storage means, and the period setting means sets a plurality of periods that do not overlap each other in the period starting at the publication of said content, according to the setting instructions for the content acquired by the information acquisition means.

3. The server for a content publishing system according to claim 1, wherein, out of the plurality of periods, the earnings provision means gives the content provider earnings that are higher the earlier the period is during which the content access was enabled by the content access enabling means.

4. The server for a content publishing system according to claim 3, further comprising:
a fee collection means for collecting a higher fee from the user the earlier the period is during which the content access was enabled by the content enabling means, out of the plurality of periods,
wherein the earnings provision means gives the content provider all or part of the fee as said earnings.

5. The server for a content publishing system according to claim 1, further comprising:
a determination means for determining whether or not content that is the same as the content stored in the content storage means has been published on an information network by other systems besides the content publishing system,
wherein the earnings provision means gives lower earnings when content that is the same as the content provided by the content access enabling means has been published by the other systems in at least one period out of the plurality of periods.

6. A non-transitory computer readable medium having machine-executable instructions with which a computer having a storage and a hardware processor, for causing a computer to function as a server for a content publishing system that publishes on an information network a plurality of content objects provided by a plurality of content providers, said computer being capable of accessing a content storage for storing content, said instructions comprising:
setting a plurality of periods that do not overlap each other in the period starting at the publication of said content, for each content object stored in the content storage;
allowing, in response to a request from a user terminal used by a user who is a content user, content designated in the request, out of the content stored in the content storage, to be accessed at the user terminal; and
giving the provider of said content earnings that vary depending on the period during which content access was enabled by the allowing, out of the plurality of periods.
